(19) United States
(12) Patent Application Publication
(10) Pub. No.: US 2015/0245888 A1
(43) Pub. Date: Sep. 3, 2015

(54) JAW REPOSITIONING APPLIANCE

(71) Applicants: Shin Hasegawa, Kanagawa (JP); Rocky Mountain Morita Corporation, Tokyo (JP); Maruemu Works Co., Ltd., Osaka (JP)

(72) Inventor: Shin Hasegawa, Kanagawa (JP)

(21) Appl. No.: 14/473,816

(22) Filed: Aug. 29, 2014

(30) Foreign Application Priority Data
Feb. 28, 2014 (JP) 2014-037794

(51) Int. Cl. A61C 7/36; A61C 7/08

(52) U.S. Cl. CPC A61C 7/36; A61C 7/08

(57) ABSTRACT

A jaw repositioning appliance has a maxillary plate fit to a maxilla, a mandibular plate fit to a mandible, and at least one connecting wire constituted with a wire rod, which has the Young's modulus of 100 GPa or lower, which has tensile strength value of 0.01 or higher with respect to the Young's modulus, and which can deform elastically. The connecting wire has at least one curved portion. One end (34, 44) of the connecting wire is attached to the maxillary plate and the other end of the connecting wire is attached to the mandibular plate.

### TECHNICAL FIELD

The present invention relates to a jaw repositioning appliance and in particular relates to a removable orthodontic appliance used for correcting a position of a mandible with respect to a maxilla to a normal state.

### BACKGROUND ART

Generally, orthodontic treatment is performed in treatment for malocclusion. The malocclusion includes a case where an abnormality exists in the shape of a dental arch as represented by crowding of teeth and also a case where an abnormality exists in a relationship between the dental arches of the maxilla and the mandible, for instance. In the treatment of the crowding and the like, an appliance called a multi-bracket appliance is fit to surfaces of teeth, whereby the shape of the dental arch is corrected by pressing or pulling the teeth. In the treatment for the case where there is an abnormality in a jaw positional relationship, a jaw repositioning appliance is used. The jaw repositioning appliance includes a form fit to on an outside using a headgear or the like and a form put inside an oral cavity. As representative appliances put inside the oral cavity, the activator, the bionator, the Bimler adapter, the Frankel function regulator and the like are commonly known. The activator is used for treatment of the maxillary protrusion or the mandibular protrusion. Guide wires of the activator are fit to the upper and lower dental arches to lead to normal occlusion. Various functional (removable) appliances have been developed based on the basic concept of the activator.

Basically, these appliances guide the abnormal jaw position or the abnormal dental arch to a normal position and are manufactured based on an artificially-induced construction bite position. The appliances use a force of muscles to return to a habitual intercuspal position as a functional force for moving the teeth and improve the jaw position by promoting a shape change of a jaw joint, thereby controlling growth and development.

It is acknowledged that the appliance having the above construction effectively functions for a labiolingual change of an anterior teeth axis and horizontal deviation of the jaw position. However, the appliance cannot fully function regarding control in a vertical direction, i.e., control of occlusal vertical dimension (height of occlusal plane). Therefore, in order to press the mandible downward, an elastic body is interposed between upper and lower molars to transmit an occlusal force (refer to Patent document 1), for instance. This is achieved by an intermittent occlusal force, and therefore, the correction of the jaw position takes a long time. As a result, a prolonged load is imposed on a patient.

### PRIOR ART DOCUMENT

### Patent Document

Patent document 1: JP-A-2008-183126

### SUMMARY OF INVENTION

### Problems to be Solved by Invention

The present invention was made in consideration of the above and has an object to provide an appliance that can shorten a jaw repositioning period by controlling an occlusal plane.

### Means for Solving Problems

The inventor of the present invention considered that functional factors of malocclusion could be solved promptly with an action of a continuous intruding force and completed the invention as follows.

That is, according to an aspect of the present invention, a jaw repositioning appliance has a maxillary plate fit to a maxilla, a mandibular plate fit to a mandible and two connecting wire constituted with wire rod that has the Young's modulus of 100 GPa or lower and that can deform elastically. The connecting wire has at least one curved portion. One end of the connecting wire is attached to the maxillary plate and the other end of the connecting wire is attached to the mandibular plate.

With the above construction, the connecting wire can deform elastically as a whole centering on the curved portion. A restoring force caused by the elastic deformation acts on both of the upper and lower plates. If the connecting wire has a shape provided with straight portions having appropriate lengths on both sides of the curved portion, the elastic deformation mainly changes a curvature of the curved portion, and also the straight portions bend. Thus, the restoring force of the entire connecting wire acts on the both end portions. If the wire rod constituting the connecting wire has low rigidity with the Young's modulus of 100 GPa or lower, stress arising in the wire can be reduced with respect to displacement of the both ends. If displacement or an angular change of the both ends (i.e., range for elastic deformation) is limited, a repetitive external force applied to the both ends can be approximated with strain amplitude. Therefore, influence on fatigue lifetime can be made small. Thus, fatigue failure due to prolonged use can be suppressed, and a moderate occlusal force can be applied continuously, whereby prompt orthodontic effect can be obtained.

When the connecting wire deforms elastically such that the both ends come close to each other, an outward reaction force arises in the both ends. Thus, the reaction force can be applied to both the maxillary plate and the mandibular plate. For example, in the case of a jaw repositioning appliance, in which both ends of the connecting wire are fixed at positions facing each other between the maxillary plate and the mandibular plate, the reaction force due to the occlusion acts in a direction of a gap between the both plates, so a downward pressing force can be applied to the mandibular plate. This enables control of the occlusal plane in the vertical direction, and the position of the mandible can be corrected in a short period with the action of the continuous occlusal force. In the case of a jaw repositioning appliance, in which the both ends of the connecting wire are fixed at positions distant from each other in the anterior-posterior direction between the maxillary plate and the mandibular plate, the reaction force due to the occlusion acts in the anterior-posterior direction of the both plates, and the pushing force for pushing out can be applied to the maxilla. This enables control of the occlusal plane in the horizontal direction, and the position of the maxilla can be corrected in a short period with the action of the continuous force also in this case.

In the above invention, the wire rod constituting the connecting wire should be preferably a wire rod, whose value of tensile strength with respect to the Young's modulus is 0.01 or higher. The value of the tensile strength with respect to the Young's modulus means a value obtained by dividing the tensile strength by the Young's modulus (hereinafter, referred to also as Young's modulus ratio of tensile strength). As the above value increases, shear strength increases, and fatigue failure due to the repetition of the shear stress accompanying the twist of the wire rod can be suppressed more. The connecting wire according to the present invention has the curved portion and the both ends divided and attached to the maxillary plate and the mandibular plate respectively. Therefore, it is anticipated that the maxilla and the mandible displace in the transverse direction due to an action such as teeth grinding. In such the case, shear stress is induced in the connecting wire by the twist caused by the displacement of the both ends. However, there is a limit to the degree of the displacement caused by the action such as the teeth grinding, and the twisting angle can be anticipated in advance. Here, by using the material having the characteristics that the Young's modulus ratio of the tensile strength is 0.01 or higher, the connecting wire can be constituted with the material having the small modulus of rigidity and high shear fatigue strength. Thus, even if the repetitive twist is applied during a predetermined period for the jaw repositioning, the appliance can be used without causing the fatigue failure.

In line with the above intent, when the material having the characteristics that an inclination of a tangent on a stress-strain diagram obtained by tensile test decreases with increase of stress in an elastic deformation range is used, the Young's modulus decreases with the increase of the acting stress. By using the characteristics of the high strength and low rigidity, the shear fatigue strength can be increased while maintaining the jaw repositioning ability. In order to exert such characteristics, a wire rod made of a titanium alloy, which has tensile elastic limit strength of 700 MPa or higher, which has characteristics that an inclination of a tangent on a stress-strain diagram obtained by tensile test decreases with increase of stress in an elastic deformation range where applied stress ranges from zero to the tensile elastic limit strength, and which has the mean Young's modulus of 75 GPa or lower, can be used. There is a marketed alloy named GUMMETAL (registered trademark) as this kind of titanium alloy.

As the external characteristics of the connecting wire of the above invention, there may be a case where a portion near the center of the straight wire rod is curved such that the connecting wire has a substantially U-shape as a whole, and also a case where two points dividing the straight wire rod into three substantially equal parts are curved in opposite directions such that the connecting wire has a substantially S-shape as a whole.

In the case where the connecting wire is formed substantially in the U-shape, the straight portions located on both sides of the curved portion protrude in the same direction from the curved portion. Both tip ends (both ends of connecting wire) are positioned to face each other and to be relatively close to each other. In this case, the straight portions can be positioned to be substantially parallel to each other. Therefore, the both ends close to each other can be attached to the maxillary plate and the mandibular plate respectively while positioning the axes of the straight portions to extend along the direction of the dentition. The connecting wire can be arranged in a state where the connecting wire can deform elastically in accordance with the change of the gap between the plates. The reaction force due to the elastic deformation can be caused in accordance with the change of the gap between the plates. The connecting wire not deforming elastically may be attached such that an appropriate gap exists between the upper and lower plates. Thus, the connecting wire deforms elastically when the upper and lower plates are moved close to each other (i.e., when biting occurs), and the reaction force at that time acts in the direction for separating the both plates, thereby applying the downward pressing force to the mandible. When the reaction force is applied to the portion near the anterior teeth of the mandible, the both ends are attached to the front portions of the upper and lower plates. When the reaction force is applied to the molars of the mandible, the both ends are attached to the rear portions of the upper and lower plates. With such the attaching manner, when the appliance according to the present invention is fit inside the oral cavity and bitten, a downward pressing force can be exerted to a predetermined position of the mandible in the construction bite position.

When the connecting wire is formed substantially in the S-shape, the both ends of the connecting wire are positioned on the both sides of the two curved portions. As for the positional relationship between the both ends, the two curved portions curved in the opposite directions intervene between the both ends. Accordingly, a relatively long distance is provided between the both ends and the tips of the ends are directed in the opposite directions. In this case, for example, one end may be attached to the front portion of the maxillary plate and the other end may be attached to the rear portion of the mandibular plate. Thus, the reaction force can be applied between the portion near the anterior teeth and the molars. By attaching the connecting wire such that the connecting wire deforms elastically when the both ends of the connecting wire come close to each other, the reaction force due to the elastic deformation acts as a force (pushing force) for pushing out the maxilla to the front on the basis of the mandible. The curved portion adjacent to the tip end on the mandibular plate side may be arranged on the side face of the maxillary plate, and the curved portion adjacent to the tip end on the maxillary plate side may be arranged on the side face of the mandibular plate. Thus, the entirety of the connecting wire can be received in the range of the side face portions of the both plates.

In this way, the connecting wire bent in the suitable shape is attached between the maxillary plate and the mandibular plate. Therefore, by using the appliance of the present invention, the occlusal plane can be controlled by performing the forward movement of the mandible. The wire rod used for the connecting wire is constituted by the material having the low Young's modulus and low rigidity. In addition, by increasing the Young's modulus ratio of the tensile strength, the fatigue failure due to the continuous and prolonged use can be inhibited. If the material has the characteristics that the inclination of the tangent on the stress-strain diagram obtained by the tensile test decreases with the increase of the stress in the elastic deformation range, the change of the stress, which occurs when the strain applied for elastically deforming the connecting wire is increased, decreases. Therefore, by increasing the change of the gap (i.e., strain) between the plates at the time when the bite occurs for occlusion, the reaction force (stress) changes nonlinearly, and a suitable reaction force can be applied to the mandible. Thus, the period for correcting the jaw position (i.e., jaw repositioning period) can be shortened.

### BRIEF EXPLANATION OF DRAWINGS

FIG. 1 is an explanatory diagram showing a first embodiment of the present invention.

FIGS. 2A through 2C are explanatory diagrams showing details of a connecting wire. FIG. 2A is a front view, FIG. 2B is a bottom plan view, and FIG. 2C is a right-side view.

FIG. 3 is a graph showing characteristics of a wire rod used for the connecting wire.

FIGS. 4A and 4B are an explanatory diagrams showing a mode of action of the first embodiment.

FIG. 5 is an explanatory diagram showing a second embodiment of the present invention.

FIGS. 6A and 6B are explanatory diagrams showing a mode of action of the second embodiment.

FIG. 7 is an explanatory diagram showing a third embodiment of the present invention.

FIGS. 8A and 8B are explanatory diagrams showing a mode of action of the third embodiment.

FIG. 9 is an explanatory diagram showing a modification of the second embodiment.

FIG. 10 is an explanatory diagram showing another modification of the second embodiment.

### MODES FOR IMPLEMENTING INVENTION

Hereinafter, embodiments of the present invention will be explained based on the drawings. In the following explanation, expressions about an up-and-down direction, a front-and-rear direction and a left-and-right direction are used. These directions are used to express positional relationships centering on a patient who uses a jaw repositioning appliance of the present invention.

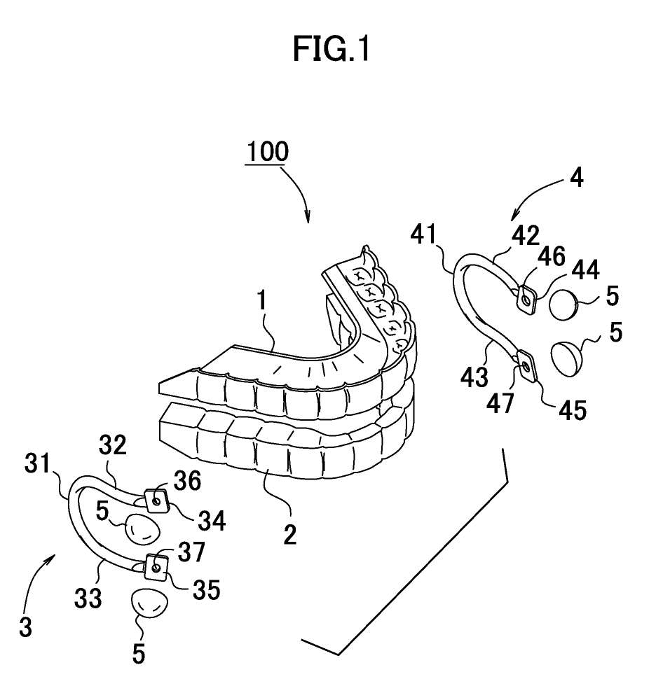

FIG. 1 is a view showing a first embodiment of the present invention. As shown in the drawing, a jaw repositioning appliance 100 according to the present embodiment is constituted with a maxillary plate 1, a mandibular plate 2 and a pair of left and right connecting wires 3, 4. The maxillary plate 1 and the mandibular plate 2 are manufactured in accordance with dentition of the patient. A general-purpose synthetic resin used as engineering plastics such as polycarbonate is used as a material of the maxillary plate 1 and the mandibular plate 2. The connecting wires 3, 4 are arranged symmetrically in a horizontal direction and the same wires are used.

Each of the connecting wires 3, 4 according to the present embodiment is formed by curving a straight wire rod, which can deform elastically, substantially at the center thereof into a substantially U-shape. The term “substantially U-shape” means a shape in which straight portions 32, 33, 42, 43 protrude in the same direction from both sides of curved portions 31, 41 respectively such that the straight portions 32, 33, 42, 43 are parallel to each other. Connections 34, 35, 44, 45 to be connected with the maxillary plate 1 and the mandibular plate 2 are formed at tip ends of the straight portions 32, 33, 42, 43 (i.e., both ends of connecting wires 3, 4). Both sides of the connections 34, 35, 44, 45 are flattened to partly have flat portions, which can contact side walls of the both plates 1, 2. A representative example of the wire rod used for the connecting wires 3, 4 according to the present embodiment has a round cross-section. Therefore, thickness of the wire rod is expressed with a diameter below. From the intent of the present invention, the cross-sectional shape of the wire rod is not limited to the round shape. Alternatively, the connecting wires 3, 4 may be constituted with a wire rod having an elliptical cross-section or a rectangular cross-section.

Both ends (connections) 34, 35, 44, 45 of the connecting wires 3, 4 are fixed to side faces of the both plates 1, 2 with a resin material 5 having an adhesive property (for instance, self-curing resin). Through holes 36, 37, 46, 47 are formed in substantially central portions of the connections 34, 35, 44, 45 (substantially central portions of flat portions) respectively. By filling the connections 34, 35, 44, 45 with the resin material 5, the connections 34, 35, 44, 45 can be adhered to the surfaces of the plates 1, 2 at the through holes 36, 37, 46, 47 as well as peripheries of the connections 34, 35, 44, 45 with the resin material 5. The connections 34, 35, 44, 45 can be firmly fixed to the plates 1, 2 by adhering them at both of the peripheries and the centers thereof. From such intent, shaping of the substantially central portions of the connections 34, 35, 44, 45 is not limited to forming the through holes 36, 37, 46, 47. Alternatively, tip end portions of the connections 34, 35, 44, 45 may be curved to form small arc-like shapes.

As the present embodiment, an orthodontic appliance for correcting Angle Class II Division 1 malocclusion is illustrated. The both ends (connections) 34, 35, 44, 45 of the connecting wires 3, 4 are attached to front portions of the maxillary plate 1 and the mandibular plate 2 (i.e., portions positioned near anterior teeth when used). When the both ends 34, 35, 44, 45 are moved close to each other (i.e., when occlusion occurs) from the upper side and the lower side, the connecting wires 3, 4 are deformed elastically such that curvatures of the curved portions 31, 41 change and the straight portions 32, 33, 42, 43 bend. Due to the elastic deformation, opposite reaction forces act on the upper and lower plates 1, 2. Further, the reaction forces act on the maxilla and the mandible through the both plates 1, 2 to exert a jaw position correcting effect (i.e., jaw repositioning effect).

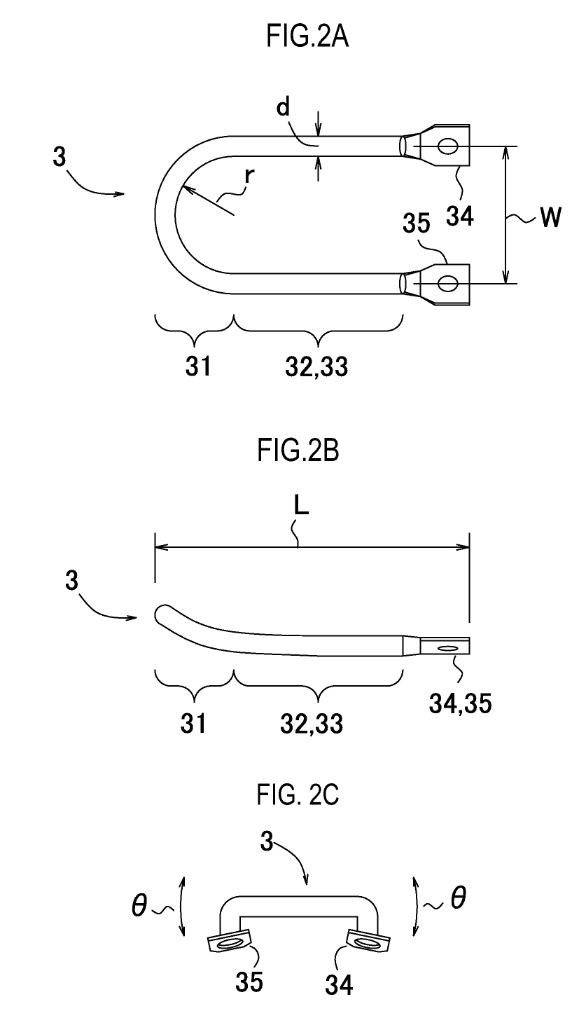

Details of the connecting wire 3 are shown in FIGS. 2A-2C. FIG. 2A is a front view, FIG. 2B is a bottom plan view, and FIG. 2C is a right-side view. As shown in FIGS. 2A-2C, the connecting wire 3 is segmented into a curved portion 31 and straight portions 32, 33. The connecting wire 3 is slightly curved as a whole along a longitudinal direction. Accordingly, the curved portion 31 is curved in three dimensions. The straight portions 32, 33 are not strictly straight but are slightly curved. In this way, the entire body of the connecting wire 3 is slightly curved in the longitudinal direction, so the connecting wire 3 can be attached along the side faces of the maxillary plate 1 and the mandibular plate 2. Further, the flat portions of the connections 34, 35 are slightly inclined as shown in the drawing. Thus, even in the case where the side faces of the plates 1, 2 are not smooth, the connections 34, 35 can properly contact the side faces. The other connecting wire 4 also has the similar construction.

The wire rod as the material constituting the connecting wires 3, 4 is required to be able to deform elastically because the present invention uses the reaction force accompanying the elastic deformation of the connecting wires 3, 4. When a material with a high Young's modulus is used, stress with respect to a predetermined strain is large. Therefore, when the both ends (connections) 34, 35, 44, 45 of the connecting wires 3, 4 are moved close to each other as desired, the stress due to the deformation becomes large. In order to obtain a desired reaction force, the diameter of the material has to be reduced and the strength becomes insufficient. Therefore, such the material is not suitable for the jaw position correction aimed by the present invention. Therefore, the connecting wires 3, 4 according to the present embodiment use a following material having the Young's modulus of 100 GPa or lower.

In this way, by using the material having the comparatively low rigidity and the low Young's modulus, the stress does not increase largely as compared to the degree of the deformation (strain) and the diameter of the wire rod can be increased. Thus, the wire rod with the high strength can be obtained. In the case of the jaw repositioning appliance 100 according to the present embodiment, displacement (change of distance) between the both ends (connections) 34, 35, 44, 45 is limited. Therefore, a large external force is not required for the elastic deformation for the small displacement, and the reaction force is not excessively large. Rather, a moderate reaction force can be obtained

More specifically, as the material of the connecting wires 3, 4 of the present embodiment, GUMMETAL (registered trademark) is used without applying heat treatment thereto. As shown in FIGS. 2A-2C, it is assumed that the wire rod having the diameter d of 1.8 mm is used, the radius r of the curved portion is processed to 7.5 mm, the distance W between the both ends is set at 15 mm, and the length L between the tip end and the end of the curved portion is set at 30 mm. When the displacement (change of distance) between the both ends (connections) 34, 35, 44, 45 is assumed to be 15 mm, the maximum bending stress is approximately 13 MPa, and the reaction force due to the displacement is approximately 15N. The reaction force is approximately the one-fourth of the case of stainless steel in the similar shape.

In this way, by using the connecting wires 3, 4 made of the material having the high strength and the low rigidity, a possibility of fatigue failure due to prolonged use can be inhibited and a moderate reaction force can be exerted continuously.

Moreover, as the characteristics of the material, the Young's modulus ratio of the tensile strength is set at 0.01 or higher to inhibit the fatigue failure due to twist. The wire rod is twisted when the positions of the both ends (connections) 34, 35, 44, 45 of the connecting wires 3, 4 move in the direction perpendicular to the direction in which the connections 34, 35, 44, 45 face each other. The shear stress leading to the breakage arises with the twist. The shear stress is maximized in the outer circumferential portion of the wire rod. Therefore, in the wire rod having the diameter of 1.8 mm, the shear stress can become relatively large. However, there is a limit in the twisting angle θ inside the oral cavity. The twisting angle θ may be assumed to be 10 degrees or smaller, and the material having the characteristics that the Young's modulus ratio of the tensile strength is equal to or higher than 0.01 may be used. Thus, the fatigue failure due to the shear stress can be inhibited.

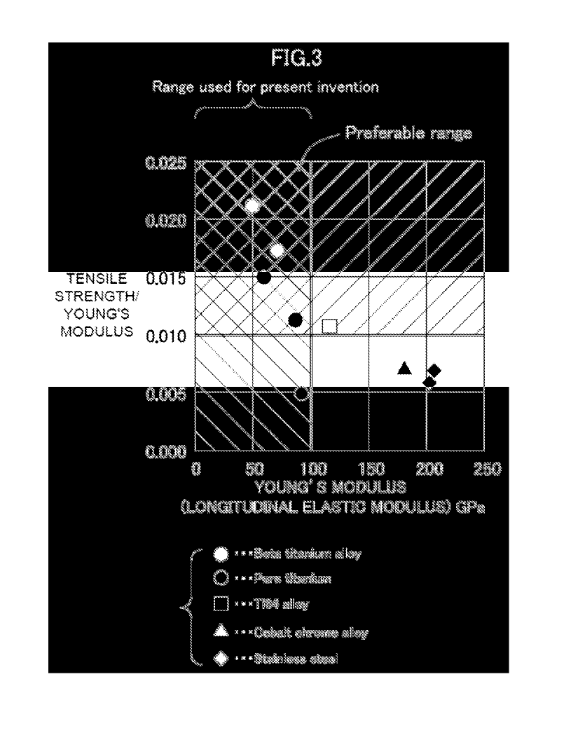

In order to select the material having the above-mentioned characteristics, Young's modulus ratios of tensile strength of various materials are obtained and shown in FIG. 3. In FIG. 3, the horizontal axis indicates the Young's modulus and the vertical axis indicates a value calculated by dividing the tensile strength by the Young's modulus. As shown in FIG. 3, a cobalt chrome alloy, stainless steel and the like have high rigidity and are not suitable for the connecting wires 3, 4. Pure titanium has low rigidity and can be used as the connecting wires 3, 4. However, the pure titanium is not desirable from a viewpoint of fatigue failure due to the above-mentioned shear stress. Various beta titanium alloys can be taken as example materials that can satisfy the above conditions. The above-mentioned GUMMETAL (registered trademark) is also included in these beta titanium alloys. Although not shown in the drawing, a Ni—Ti alloy, a Ni—Ti—Co alloy, a Ni—Ti—Cu alloy or the like as a publicly known shape memory alloy may be used. Although such the Ni—Ti family alloys have different tensile strengths between the mother phase (austenitic phase) and the martensitic phase, the above conditions are satisfied in the both phases. However, it should be noted that this kind of alloy has low twisting torque and can be easily twisted. Therefore, process for inhibiting the twist such as modifying a cross-sectional shape or thickness partially is required. Therefore, the above-mentioned Ni—Ti family alloys may be used for the connecting wires 3, 4 of the present embodiment but the beta titanium alloy is used preferably.

In this way, by using the material having the low rigidity with the Young's modulus of 100 GPa or lower and the high strength with the tensile strength of 0.01 or higher with respect to the Young's modulus, the fatigue failure can be inhibited even in the state where the connecting wires 3, 4 receive the twisting deformation in addition to the bending deformation. Thus, a moderate reaction force can be exerted while maintaining the strength with the wire rod having the sufficient diameter.

As mentioned above, the Young's modulus is set to 100 GPa or lower. When the material has characteristics that an inclination of a tangent on a stress-strain diagram obtained by a tensile test decreases with an increase of stress, the above-mentioned Young's modulus means an average Young's modulus. In this case, since the Young's modulus changes nonlinearly and decreases gradually, it is meant that the stress change at the time when the strain becomes large is small, so the strength at the time when large displacement occurs can be secured. The GUMMETAL (registered trademark) is defined as a titanium alloy, which has tensile elastic limit strength of 700 MPa or higher, which has characteristics that an inclination of a tangent on a stress-strain diagram obtained by a tensile test decreases with an increase of the stress in an elastic deformation range where the applied stress ranges from zero to the tensile elastic limit strength, and which has an average Young's modulus of 75 GPa or lower, and therefore satisfies the above-mentioned conditions. The characteristics of the GUMMETAL (registered trademark) are described in detail in Japanese patent No. 3375083.

Next, specific appliances according to the above-mentioned embodiment for correcting malocclusion will be explained.

### (Correction of Angle Class II Division 1 Malocclusion)

The embodiment shown in FIG. 1 is used for the orthodontic treatment of the Angle Class II Division 1 malocclusion. The Angle Class II Division 1 malocclusion is mandibular distocclusion accompanied by protrusion of the maxillary anterior teeth. In the case of this kind of malocclusion, the front end (portion near anterior teeth) of the mandible is located posterior to the maxillary anterior teeth. By pressing the mandibular anterior teeth portion downward, the protrusion of the maxillary anterior teeth can be also corrected. Therefore, in the present embodiment, the both ends 34, 35, 44, 45 of the connecting wires 3, 4 are attached to points near the front portions of the upper and lower plates 1, 2 as shown in the drawing. Thus, when the connecting wires 3, 4 deform elastically such that the both ends 34, 35, 44, 45 come close to each other, a pressing force is applied to the portions near the mandibular anterior teeth by using reaction forces of the connecting wires 3, 4.

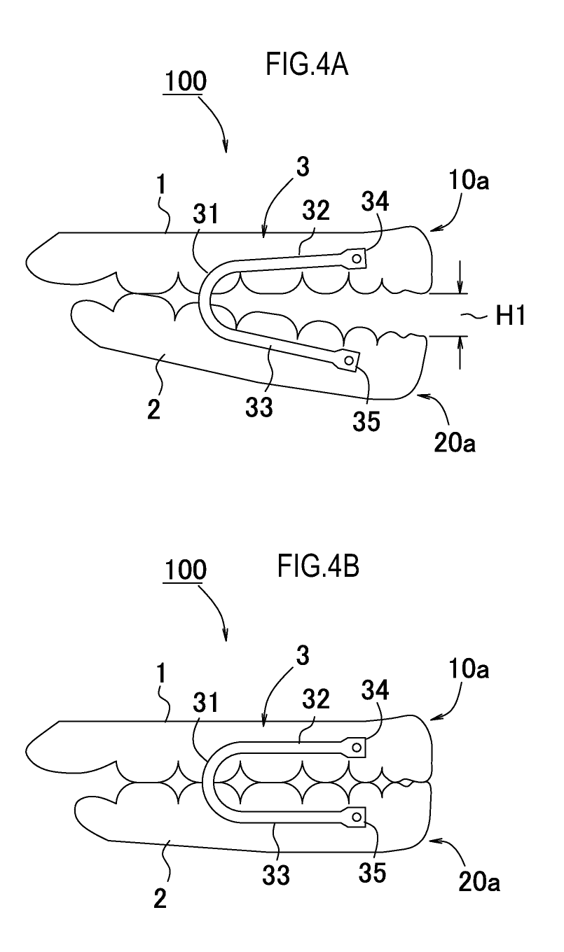

In the jaw repositioning appliance 100 according to the present embodiment, as shown in FIGS. 4A and 4B, the connecting wire 3 (connecting wire 4 is not shown in the drawing) is attached to outside side faces of the upper and lower plates 1, 2. The both ends 34, 35 are attached to positions near front portions 10a, 20a of the plates 1, 2. In order to make the connecting wire 3 act functionally, an appropriate interval H1 is formed between facing end edges of the front portions 10a, 10b of the upper and lower plates 1, 2 in a state where the elastic deformation is not caused as shown in FIG. 4A. From this state, the facing end edges of the upper and lower plates 1, 2 are brought into contact with each other as shown in FIG. 4B. Thus, the connecting wire 3 deforms elastically and the reaction force acts between the both plates 1, 2.

The reaction force of the connecting wire 3 acting between the both plates 1, 2 is concentrated on the both ends 34, 35. Therefore, by attaching the both ends 34, 35 to the positions near the front portions 10a, 20a of the plates 1, 2 as mentioned above, the reaction force can be concentrated on the positions. The force acts in a direction for opening the plates 1, 2 (i.e., direction for separating them). When the appliance of the present embodiment is used, the reaction force acting on the front portions 10a, 20a of the plates 1, 2 acts on the maxilla and the mandible through the plates 1, 2. Therefore, when the jaw repositioning appliance of the present embodiment is used, the downward pressing force is applied to the position near the mandibular anterior teeth. Thus, vertical control of the occlusal plane is enabled, and the correction of the Angle II Division 1 malocclusion can be made effective.

The connecting wire 3 is attached to the upper and lower plates 1, 2 in a state where the mandibular position is adjusted beforehand. The adjustment is performed to achieve the construction bite position (state shown in FIG. 4B), and then, the connecting wire 3 is deformed plastically to form the predetermined gap H1 between the both ends 34, 35. In this way, the plates 1, 2 are positioned to achieve the construction bite position in advance, and then, the attached connecting wire 3 is deformed plastically. Thus, the direction of the deformation at the time when the connecting wire 3 deforms elastically leads to the intercuspal position. That is, since the plastic deformation is achieved only with the change of the curvature of the curved portion 31, the elastic deformation also changes the curvature of the curved portion 31.

Since the upper and lower plates 1, 2 are manufactured in accordance with the shape of teeth of the patient, no member for fixation is necessary, and the appliance is removable. Also, it is expected that the protruding maxillary anterior teeth change to a normal position with the correction of the mandibular position. Therefore, consideration is given to forming a suitable gap for allowing the change of the maxillary teeth, for example.

### (Correction of Openbite)

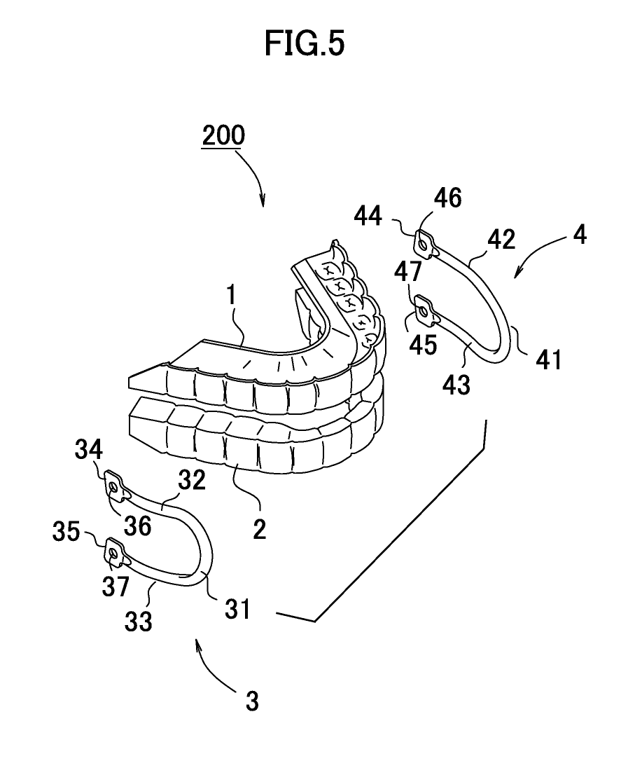

Next, an embodiment used for correction of openbite will be explained as a second embodiment of the present invention. FIG. 5 is a view showing the present embodiment. As shown in the drawing, as in the first embodiment, a jaw repositioning appliance 200 according to the present embodiment uses upper and lower plates 1, 2 and a pair of connecting wires 3, 4 curved substantially in the U-shape. However, the attached state of the connecting wires 3, 4 is changed in the jaw repositioning appliance 200 according to the present embodiment. That is, the both ends 34, 35, 44, 45 of the connecting wires 3, 4 are attached to rear portions of the plates 1, 2 respectively.

The present embodiment is used for correction of openbite, which is malocclusion that the maxillary and mandibular anterior teeth are open when the molar parts of the maxilla and the mandible bite. In the case of such the malocclusion, normal occlusion can be realized by pressing down the molar parts as correction. Therefore, in the present embodiment, the both ends 34, 35, 44, 45 of the connecting wires 3, 4 are attached to the rear portions of the plates 1, 2. Thus, the reaction force caused by the elastic deformation is concentrated and applied to the molar parts. Since the direction of the connecting wires 3, 4 is opposite to the first embodiment, the curved portions 31, 41 are located ahead of the both ends 34, 35, 44, 45. The straight portions 32, 33, 42, 43 can be arranged along the rows of the teeth like the first embodiment.

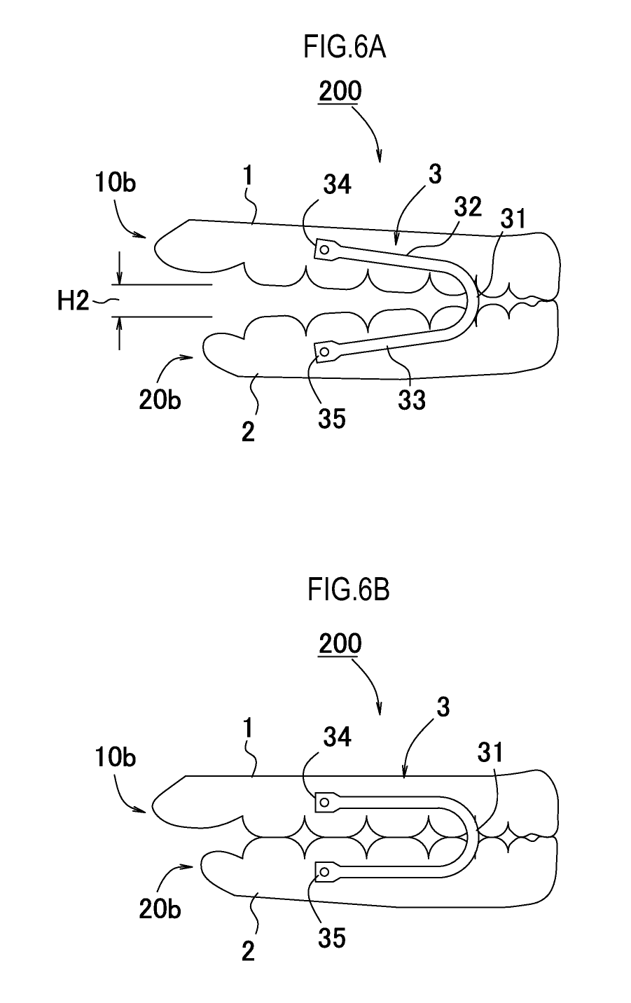

FIGS. 6A and 6B are side views of the present embodiment. As shown in FIGS. 6A and 6B, the direction of the connecting wire 3 of the present embodiment (connecting wire 4 is not shown in the drawing) is opposite to the first embodiment but the used connecting wire 3 is the same as the first embodiment. As shown in FIG. 6A, an appropriate gap H2 is formed between facing end edges of the rear portions 10b, 20b of the upper and lower plates 1, 2 in a state where the elastic deformation is not caused. This is for applying the reaction force, which acts on the connecting wire 3 due to the occlusion, to the molar parts. That is, as shown in FIG. 6B, by bringing the facing end edges of the upper and lower plates 1, 2 into contact with each other, the connecting wire 3 deforms elastically. The reaction force can be applied to the rear portions 10b, 20b of the both plates 1, 2 through the both ends 34, 35 of the connecting wire 3.

Also in the present embodiment, when the connecting wire 3 is attached, the occlusal position is adjusted beforehand (refer to FIG. 6B). Then, the connecting wire 3 is deformed plastically to change the curvature of the curved portion 31. Then, the predetermined gap H2 is formed between the contacting-side end edges of the rear portions 10b, 20b of the both plates 1, 2 (refer to FIG. 6A). By fitting the jaw repositioning appliance 200 having the above construction, the force for pressing down can be applied to the mandibular molar parts through the occlusal action, thereby correcting the position of the mandible.

### (Correction of Anterior Crossbite)

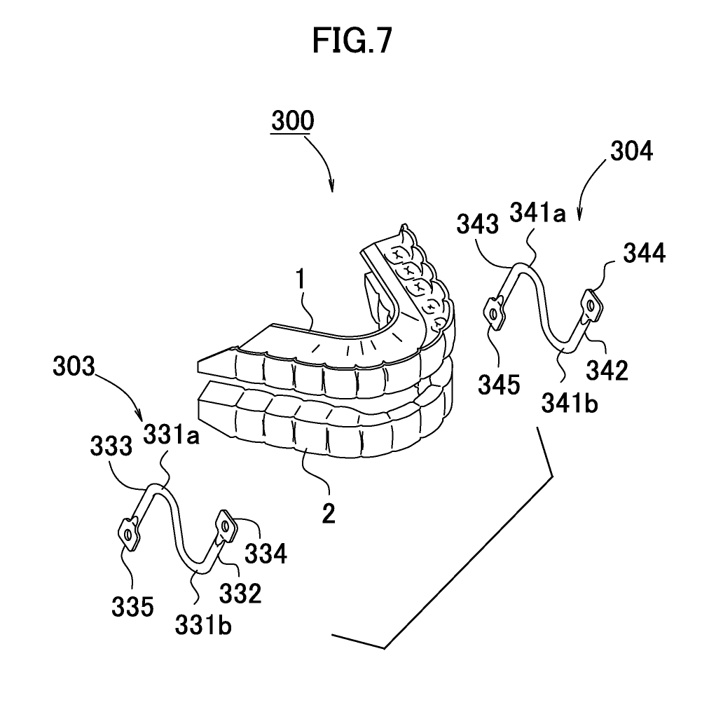

Next, an embodiment used for correction of anterior crossbite will be explained as a third embodiment of the present invention. FIG. 7 is a view showing the present embodiment. As shown in the drawing, a jaw repositioning appliance 300 according to the present embodiment uses upper and lower plates 1, 2 similar to those of the first embodiment, but the constructions of connecting wires 303, 304 are changed. That is, curved portions 331a, 331b, 341a, 341b are formed at two points of the connecting wires 303, 304 respectively, and straight portions 332, 333, 342, 343 protrude from both ends thereof in opposite directions. Thus, the connecting wires 303, 304 are formed substantially in S-shapes respectively. Both ends 334, 335, 344, 345 of the connecting wires 303, 304 are located at tip ends of the straight portions 332, 333, 342, 343 respectively and are arranged to have appropriate distances therebetween. The drawing shows the state where the straight portions 332, 333, 342, 343 have appropriate lengths. If the curvatures of the curved portions 331a, 331b, 341a, 341b are set small (i.e., when radii are set large), the straight portions 332, 333, 342, 343 are short. As an extreme case, there may be a case where the straight portions 332, 333, 342, 343 are not formed. The gist of the present embodiment is that the respective two curved portions 331a, 331b, 341a, 341b formed to be curved in the opposite directions provide the substantially S-shapes and that one ends 334, 344 can be attached to the maxillary plate 1, and the other ends 335, 345 can be attached to the mandibular plate 2.

In this way, the connecting wires 303, 304 are formed substantially in the S-shapes such that the both ends have appropriate gaps therebetween in the anterior-posterior direction when the one ends 334, 344 are attached to the maxillary plate 1 and the other ends 335, 345 are attached to the mandibular plate 2. When the connecting wires 303, 304 are deformed to shorten the distances between the both ends 334, 335, 344, 345 (i.e., when both ends 334, 335, 344, 345 come close to each other in anterior-posterior direction), outward reaction forces are exerted in the anterior-posterior direction. The present embodiment aims to apply the reaction force to the maxillary plate 1 forward in order to correct the anterior crossbite. The anterior crossbite is malocclusion accompanied by protrusion of the mandibular anterior teeth. When this kind of malocclusion is corrected, the reaction force (pushing-out force) is exerted to push out the maxilla forward on the basis of the mandible.

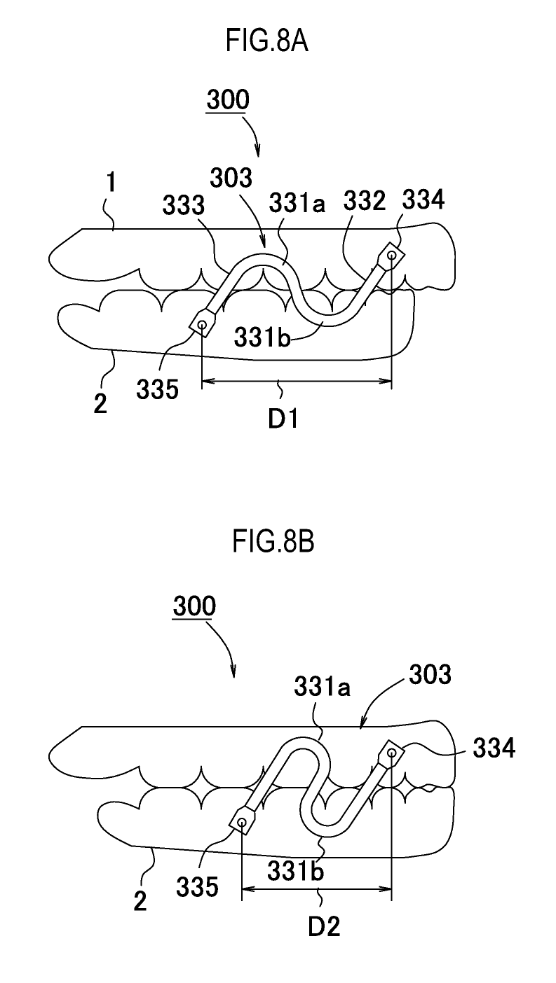

FIGS. 8A and 8B are side views of the present embodiment (the other connecting wire 304 is not shown in the drawing). FIG. 8A shows a state where the connecting wire 303 is not deformed elastically, and FIG. 8B shows a state where the connecting wire 303 is deformed elastically. As shown in the drawings, the maxillary plate 1 is positioned ahead of the mandibular plate 2 in the state where the connecting wire 303 is not deformed elastically. When the mandibular plate 2 moves forward from this state, the connecting wire 303 is deformed elastically and the reaction force due to the elastic deformation acts on the maxilla in a forward direction.

That is, in the state where the connecting wire 303 is not deformed elastically, as shown in FIG. 8A, the one end 334 of the connecting wire 303 is attached to the maxillary plate 1 and the other end 335 of the connecting wire 303 is attached to the mandibular plate 2 such that the axes of the straight portions 332, 333 are perpendicular to the direction of the row of the teeth or are slightly angled with respect to the row of the teeth. At that time, the one end 334 is attached to a front portion of the maxillary plate 1, and the other end 335 is attached to a rear portion of the mandibular plate 2. The maxillary plate 1 is positioned ahead of the mandibular plate 2. Therefore, an appropriate gap D1 is formed between the both ends 334, 335. The curved portion 331a abutting the one end 334, which is attached to the maxillary plate 1, is positioned on a side of the mandibular plate 2. The curved portion 331b abutting the other end 335, which is attached to the mandibular plate 2, is positioned on a side of the maxillary plate 1. Thus, the entire connecting wire 303 is received in the range of the side face of the appliance formed by the both plates 1, 2.

When the patient suffering from the anterior crossbite uses the appliance in the state where the above-mentioned elastic deformation is not caused, the mandibular plate 2 is led forward by the mandible of the patient. As mentioned above, the anterior crossbite is accompanied by the protrusion of the mandibular anterior teeth, and the maxilla is positioned backward from (or distal to) the mandible. Therefore, the mandible acts to move forward compared to the maxilla. In this way, due to the forward movement of the mandibular plate 2, the both ends of the connecting wire 303 are compressed. Thus, as shown in FIG. 8B, while the substantially S-shape connecting wire 303 deforms elastically centering on the curved portions 331a, 331b, the both ends 334, 335 come close to each other. At that time, the gap D2 between the both ends 334, 335 decreases, and the reaction force due to the elastic deformation thereof acts to increase the gap between the both ends 334, 335.

In this way, when the patient suffering from the anterior crossbite uses the present embodiment, the mandible pushes out the mandibular plate 2 forward, thereby elastically deforming the connecting wire 303. The reaction force acts on the maxilla as the pushing force and exerts the effect of correcting the jaw position.

Also in this case, the attaching of the connecting wire 303 is performed in a state where the occlusal position is adjusted (refer to FIG. 8B). Then, the plastic deformation is caused to change the curvatures of the curved portions 331a, 331b (refer to FIG. 8A). Thus, the jaw position can be corrected to achieve the normal occlusion state.

The embodiments of the present invention are described above, but the present invention is not limited to the illustrated embodiments. Therefore, the above-mentioned embodiments can be suitably changed within the scope of the spirit of the present invention. Hereinafter, modification examples of the present invention will be explained.

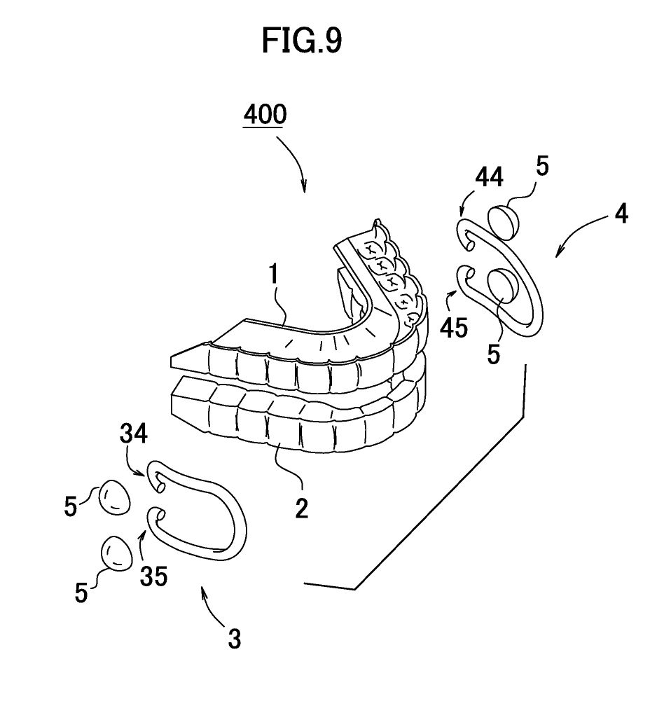

FIG. 9 shows a modification of the second embodiment (refer to FIG. 5). As shown in the drawing, in an appliance 400 of this modification, construction and the attaching method of the connecting wires 3, 4 of the second embodiment are changed. That is, the both ends 34, 35, 44, 45 of the connecting wires 3, 4 are curved inward into arc-like shapes respectively. Since the both ends 34, 35, 44, 45 are formed in the arc-like shapes, flat portions are not formed. Instead, peripheries of the arc-like portions can contact appropriate areas of the side faces of the plates 1, 2. Also in such the construction, the arc-like portions may be covered with a resin material 5 having an adhesive property (for instance, self-curing resin). Thus, the peripheries and the inside of the arc-like portions are filled with the resin material 5 and the entire area where the arc-like portions are formed can be adhered firmly.

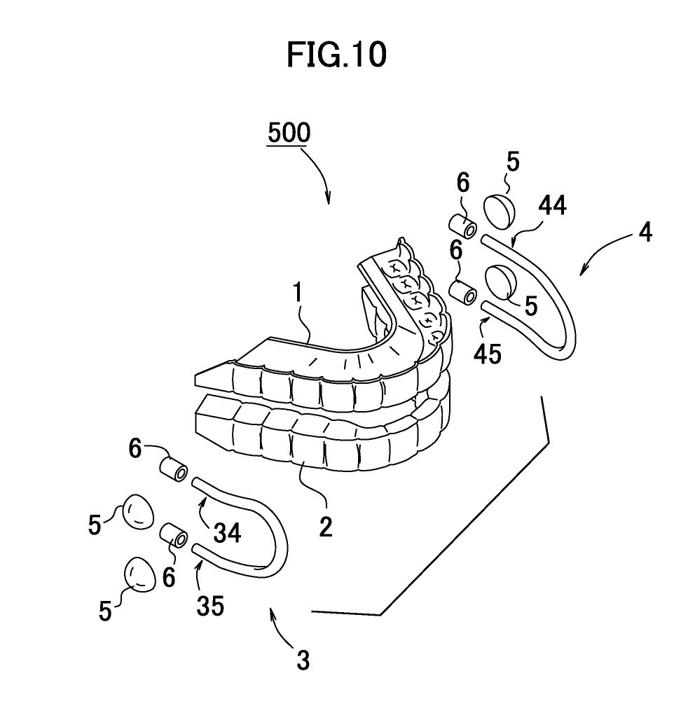

FIG. 10 shows another modification. As shown in the drawing, in an appliance 500 of this modification, both ends 34, 35, 44, 45 of the connecting wires 3, 4 are attached to the both plates 1, 2 through cylindrical receiving parts 6. More specifically, the receiving parts 6 are fixed to the both plates 1, 2 with a resin material (such as self-curing resin) 5, and the both ends 34, 35, 44, 45 are inserted into inner hollows of the receiving parts 6. The both ends 34, 35, 44, 45 are formed in the straight shapes, each of which has a round cross-section. In the case of such the construction, the connecting wire 3 is attached such that the both ends 34, 35, 44, 45 of the connecting wire 3 can perform rotation in the circumferential direction (i.e., rotation in both of right direction and opposite direction) respectively. In this way, the both ends 34, 35, 44, 45 of the connecting wires 3, 4 can rotate in the circumferential direction in the state where the both ends 34, 35, 44, 45 are attached to the both plates 1, 2. Accordingly, when twist is caused in the connecting wires 3, 4 due to teeth grinding or the like, the twist can be canceled in the range where the both ends 34, 35, 44, 45 can rotate.

The modification examples are illustrated above. Further changes to the embodiments and the modifications thereof are also possible. The material to be used can be also selected arbitrarily. For instance, the receiving part 6 used in the above modification can be constituted with the resin material. Alternatively, the receiving part 6 may be constituted with a metal material in order to maintain strength.

In the above embodiments and the modifications, the plates 1, 2 are made of the polycarbonate. Alternatively, polyvinyl chloride (PVC) can be used. Further, a synthetic resin widely used as engineering plastics may be used as long as the resin can keep sufficient strength.

### EXPLANATION OF REFERENCE NUMERALS

1 Maxillary plate
2 Mandibular plate
3, 4, 303, 304 Connecting wire
5 Resin material
6 Receiving part
31, 41, 331a, 331b, 341a, 341b Curved portion
32, 33, 42, 43, 332, 333 Straight portion
34, 35, 44, 45, 334, 335, 344, 345 Both ends of connecting wire
100, 200, 300, 400, 500 Jaw repositioning appliance

What is claimed is:

1. A jaw repositioning appliance, comprising:
a maxillary plate fit to a maxilla;
a mandibular plate fit to a mandible;
at least one connecting wire constituted with a wire rod that has the Young's modulus of 100 GPa or lower and that can deform elastically, wherein
the connecting wire has at least one curved portion, and
one end of the connecting wire is attached to the maxillary plate and the other end of the connecting wire is attached to the mandibular plate.

2. The jaw repositioning appliance as in claim 1, wherein
the wire rod constituting the connecting wire is a wire rod, whose value of tensile strength with respect to the Young's modulus is 0.01 or higher.

3. The jaw repositioning appliance as in claim 2, wherein
the wire rod constituting the connecting wire has characteristics that an inclination of a tangent on a stress-strain diagram obtained by tensile test decreases with increase of stress in an elastic deformation range.

4. The jaw repositioning appliance as in claim 3, wherein
the wire rod constituting the connecting wire is a titanium alloy, which has tensile elastic limit strength of 700 MPa or higher, which has characteristics that an inclination of a tangent on a stress-strain diagram obtained by tensile test decreases with increase of stress in an elastic deformation range where applied stress ranges from zero to the tensile elastic limit strength, and which has the mean Young's modulus of 75 GPa or lower.

5. The jaw repositioning appliance as in claim 1, wherein
one of the connecting wires is attached to left-side outer faces of the maxillary plate and the mandibular plate, and
the other one of the connecting wires is attached to right-side outer faces of the maxillary plate and the mandibular plate.

6. The jaw repositioning appliance as in claim 1, wherein
the connecting wire has a round cross-sectional shape, and
the connecting wire is attached to the maxillary plate and the mandibular plate such that the connecting wire can rotate in a circumferential direction.

7. The jaw repositioning appliance as in any one of claims 1 to 6, wherein
the connecting wire is formed substantially in a U-shape having a curved portion and both ends arranged in a vertical direction,
one end of the connecting wire is attached to the maxillary plate and the other end of the connecting wire is attached to the mandibular plate, and
when the connecting wire is deformed to bring the both ends thereof close to each other such that occlusion of the both plates occurs, the connecting wire exerts an outward reaction force to apply a downward pushing force at a position where the connecting wire is attached to the mandibular plate.

8. The jaw repositioning appliance as in any one of claims 1 to 6, wherein
the connecting wire is formed substantially in a S-shape having two curved portions, which are curved in opposite directions, with both ends arranged in an anterior-posterior direction and a vertical direction,
one end of the connecting wire is attached to a front portion of the maxillary plate and the other end of the connecting wire is attached to a rear portion of the mandibular plate, and
when the connecting wire is deformed to bring the both ends thereof close to each other such that occlusion of the both plates occurs, the connecting wire exerts an outward reaction force to apply a backward pushing force at a position where the connecting wire is attached to the mandibular plate.
